(19) United States
(12) Patent Application Publication
(10) Pub. No.: US 2014/0041862 A1
(43) Pub. Date: Feb. 13, 2014

(54) Use of Magnetic Liquids for Imaging and Mapping Porous Subterranean Formations

(71) Applicant: Halliburton Energy Services, Inc., Houston, TX (US)

(72) Inventor: Haluk Vefa Ersoz, The Woodlands, TX (US)

(73) Assignee: Halliburton Energy Services, Inc., Houston, TX (US)

(21) Appl. No.: 13/953,053

(22) Filed: Jul. 29, 2013

Related U.S. Application Data
(60) Provisional application No. 61/680,499, filed on Aug. 7, 2012.

(51) Int. Cl. G01V 3/30; E21B 47/00

(52) U.S. Cl. CPC G01V 3/30; E21B 47/00
USPC 166/250.1; 324/346

(57) ABSTRACT

Methods and systems for illuminating the pore space or portions thereof of a subterranean formation may use magneto-responsive ionic liquid surfactant. For example, a method may include injecting a treatment fluid comprising a base fluid and at least one magneto-responsive ionic liquid surfactant into a wellbore penetrating a subterranean formation having a pore space; measuring a local geo-electromagnetic field within the subterranean formation at a first time and a second time; and determining a property of the pore space of the subterranean formation based on differences between the local geo-electromagnetic field at the first time and the second time.

### BACKGROUND

The exemplary embodiments described herein relate to methods and systems for illuminating the pore space (or portions thereof) with a subterranean formation may use magneto-responsive ionic liquid surfactant.

Certain types of geologic strata of subterranean formations have pore spaces that include space between individual rocks, within the rock structure, or along natural fractures. As used herein, the term “pore space” refers to the voids (e.g., fractures, cracks, bubbles, cavities, inter-particle spaces, and inter-crystal spaces) within a subterranean that contain fluids. The fluids within the pore spaces may include, inter alia, oil, gas, and water. Portions of the pore space that are fluidly connected form a flow path within the subterranean formation. The flow paths, if fluidly connected to a wellbore penetrating the subterranean formation may be useful for injecting fluids into the formation or producing fluids from the formation.

In some instances, hydraulic fracturing is used to enhance the fluid connectivity of the pore space. In hydraulic fracturing, fluid is injected at a pressure greater than the matrix pressure so as to create or extend at least one fracture, natural or man-made, in the subterranean formation. Then, a treatment fluid that includes proppants is introduced into the fractures to mechanically prevent fracture closing, which creates or expands flow paths within the pore space to increase connectivity and conductivity.

Information corresponding to the geometry and permeability of the pore space of a formation is helpful in determining the design parameters of future subterranean operations (e.g., completion operations, fracturing operations, production operations, and the like). Conventional methods for mapping the pore space of a formation typically include pressure and temperature analysis, seismic sensors, tilt-meters, observational analysis, and micro-seismic monitoring of fracture formation during a fracturing operation. Each of these methods have their drawbacks, including complicated de-convolution of acquired data, a generalized reliance on assumed parameters, and the common application of educated guesswork as to the connectivity of the pore space of the formation. For example, mapping-while-fracturing methods measure the shape of the fractures during the fracturing rather than after the fractures have closed and been propped open by the proppant. Further, in each of these measurements, the pore space may be mapped, but it is common to apply educated guesswork to the connectivity of the pore space.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a schematic illustration of a primary well and monitoring wells with sensors suitable for use in conjunction with at least some of the pore space illuminations methods described herein.

FIGS. 2A-2D depict the motion of a drop of the MILS of FIG. 1B as a magnet is brought into proximity, according to certain aspects of the present disclosure.

### DETAILED DESCRIPTION

The exemplary embodiments described herein relate to methods and systems for illuminating the pore space (or portions thereof) within a subterranean formation may use magneto-responsive ionic liquid surfactant.

It will be appreciated that although the systems and methods disclosed herein are discussed in relation to a vertical well, it should be understood by those skilled in the art that the system of the present invention is equally well-suited for use in wells having other configurations including deviated wells, inclined wells, horizontal wells, multilateral wells and the like. Accordingly, use of directional terms such as “above,” “below,” “upper,” “lower” and the like are used for convenience in referring to the illustrations. Also, even though the discussion refers to land-based well operations, it should be understood by those skilled in the art that the systems and methods can also be employed in any offshore operation, without departing from the scope of the disclosure.

The properties of the pore space of a subterranean formation may be determined using illumination methods where a fluid comprising contrast agents is injected into the formation so as to permeate the pore space and the location of the contrast agents is detected. As used herein the term “illumination” refers to methods that utilize contrast agents and corresponding detecting instrumentation (e.g., sensor) to differentiate an area, feature, or the like of interest from the surround area.

Examples of properties of the pore space that may be determined with the illumination methods described herein may include, but are not limited to, porosity, permeability, dimensions, connectivity, and the like, and any combination thereof, many of which are difficult to accurately determine with traditional methods like seismic analysis that analyze the pore space of a formation.

A common contrast agent used in subterranean formations is super-paramagnetic colloidal particles that are typically about 1 to about 100 nm in diameter (e.g., ferrofluids). Such colloidal particles may be referred to as “nanoparticles.” These nanoparticles are suspended in a fluid that is injected into the subterranean. However, the particles often require coating to enhance suspendability and minimize agglomeration. Additionally, the density of the particles tends to cause settling of the particles. Further, depending on their diameter, the particles may not be able to traverse the smaller portions of the pore space, especially if they are agglomerated. Together, these drawbacks can lead to inaccurate measurements of the pore space.

In some embodiments, a magneto-responsive ionic liquid surfactant (“MILS”) may be used in conjunction with pore space illumination methods to determine properties of the pore space of the formation. Generally, MILS are non-volatile molecular liquids with high magnetic susceptibility (e.g., 10,000 or greater). By contrast, the magnetic susceptibility of subterranean formations typically range from about 10⁻⁶ for sand and limestone to about 10⁻³ for sandstones. Without being limited by theory, it is believed that because of the high magnetic susceptibility of the MILS, the MILS will alter the local geo-electromagnetic field proximal to the location of the MILS. As used herein, the term “geo-electromagnetic field” refers to the Earth's electromagnetic field which comprises two closely related geophysical fields: the geomagnetic field and the geoelectric field. The changes in the local geo-electromagnetic field within the subterranean formation due to the presence of MILS may be used to determine various properties of the void space of the subterranean formation.

Because the MILS are molecules rather than colloidal particles, the MILS may be able to infiltrate interstitial spaces, smaller pores, and vugs of the pore space of a subterranean formation, which, in turn, may provide a more accurate illumination methods and properties of the pore space like permeability, dimensions, connectivity, and the like, and any combination thereof. The properties of the pore space may be valuable in the determining if and where another wellbore should be drilled, if and where additional completion operations (e.g., fracturing, acidizing, diverting, plugging, and the like) should be performed to maximize hydrocarbon production from the subterranean formation, and the like. For example, a thief zone may be identified where a plugging or diversion operation may be useful. In another example, a hydrocarbon deposit may be identified as not being fluidly connected to the pore space, and a stimulation operation like fracturing may be performed proximal to the hydrocarbon deposit.

It should be noted that when “about” is provided herein at the beginning of a numerical list, “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

The MILS described herein may, in some embodiments, comprise a cationic surfactant having a magnetically susceptible counterion. Examples of suitable cationic surfactants may, in some embodiments, include, but are not limited to, C₆-C₂₂ alkylamines, quaternary ammonium surfactants having at least one C₆-C₂₂ group, (C₆-C₂₂ alkyl)-trimethylammonium surfactants, di-(C₆-C₂₂ alkyl)-dimethylammonium surfactants, benzalkonium surfactants where the alkyl group is C₆-C₂₂, (C₆-C₂₂ alkyl)-imidazole surfactants, and the like, and any derivative thereof. Examples of suitable magnetically susceptible counterions may, in some embodiments, include, but are not limited to, anions of iron chloride (FeCl₄), iron chloride bromide (FeCl₃Br), dysprosium chloride (DyCl₃), dysprosium sulfide (Dy₂S₃), gadolinium chloride (GdCl₃), erbium sulfide (Er₂S₃), manganese chloride (MnCl₂), and the like, and any derivative thereof. Any combination of the foregoing cationic surfactants and magnetically susceptible counterion ions may be useful as MILS for use in conjunction with methods described herein. Further, some embodiments of the methods described herein may utilize a combination of two or MILS.

In some instances, the MILS in an aqueous fluid may be highly acidic (e.g., pH less than about 1 at a concentration of about 20% by weight of the fluid). Consequently, as will be appreciated by those skilled in the art, such an acidic MILS may be used simultaneously as both a reactive acid and an imaging agent during some acid-treatment processes.

In some instances, the MILS may be used in conjunction with other contrast agents like the ferrofluids described herein.

In some instances, the MILS may be used in determining a property of the pore space of the subterranean formation (e.g., porosity, permeability, dimensions, connectivity, and combinations thereof). The related methods may involve injecting a MILS fluid into a subterranean formation (e.g., via a wellbore penetrating the formation), measuring the local geo-electromagnetic field within the subterranean formation at two or more times, and determining a property of the pore space of the subterranean formation based on differences between the measurement at different times. In some instances, one of the times may be prior to injection of the MILS into the subterranean formation. The time difference between measurement times may be negligible (i.e., continuous measurement) to minutes, days, months, or longer. As used herein, the term “MILS fluid” refers to any treatment fluid comprising MILS.

MILS fluids may be any treatment fluid that comprises a base fluid and at least one MILS and is suitable for use in a subterranean formation. Suitable base fluids may be aqueous fluids, oleaginous fluids, oil-in-water emulsions, or water-in-oil emulsions. The MILS fluids may include the at least one MILS in an amount of about 5% by weight of the base fluid to about 95% by weight of the base fluid. One of ordinary skill in the art, with the benefit of this disclosure will recognize the other additives suitable for including a MILS fluid depending on the subterranean operation in which the MILS are implemented in conjunction with. For example, in conjunction with fracturing operations, the MILS fluid may, in some instances, further comprise a viscosifier and optionally proppant depending on if the MILS are implements in conjunction with the pad fluid or the proppant slurry, each described further herein.

Measuring the local geo-electromagnetic field within the subterranean formation may be achieved by measuring the magnetic permeability, electrical conductivity, and electromagnetic field of the subterranean formation with one or more sensors. As used herein, the term “sensor” refers to passive sensors that include a receiver and active sensors that include transmitters and receivers (which may be separate or in a single device). Examples of sensors capable of measuring the magnetic permeability, electrical conductivity, and electromagnetic field may include, but are not limited to, magnetometers (e.g., a magnetometer assembly comprising three magnetometers arranged along the Cartesian axes), electromagnetic field detectors, subsurface radar systems, magnetic susceptibility sensors, magnetotelluric systems, and the like. In some instances, more than one sensor may be utilized including multiple sensors of the same type, multiple types of sensors, and a combination thereof. For example, magnetometers having more precise spatial resolution may be used in conjunction with electromagnetic instrumentation having greater depth penetration into the subterranean formation. Measuring the local geomagnetic field and the local geoelectric field in such a way may yield more accurate illumination of the pore space.

One of ordinary skill in the art with the benefit of this disclosure should recognize the ways to determine properties of the pore space based on the illumination methods described herein. For example, measuring and comparing the local geo-electromagnetic field within the subterranean formation before injection of the MILS and after the fluid containing the MILS has flooded the formation may provide the dimensions and connectivity of the pore space. In another example, including the MILS at the local geo-electromagnetic field within the subterranean formation at a first time and a second time as the fluid containing the MILS infiltrates the pore space may provide data to quantify porosity and permeability of the pore space as well as information about the dimensions and connectivity of the pore space.

The data from the measurements may be used for producing a multi-dimensional map or profile of the property of pore space (e.g., spatial 3-D maps/profiles or 4-D maps/profiles that relate time and space). In some instances, the data or maps/profiles of the pore space may be compared to other formation data (e.g., seismic data, logging data, and the like).

Some embodiments may involve performing illumination methods described herein without significantly altering the structure of the pore space (i.e., with minimal to no fracturing the subterranean formation during the illumination method). As described above, the pore space being illuminated may comprise both natural and man-made flow paths. In some instances, injecting a MILS fluid into a subterranean formation may involve continuously introducing the MILS fluid into the subterranean formation. In some instances, injecting a MILS fluid into a subterranean formation may involve injecting a volume of MILS fluid into the subterranean formation and pushing the volume of the MILS fluid through the subterranean formation with a fluid that does not include MILS, which may advantageously reduce the total amount and cost associated with the pore space illumination method.

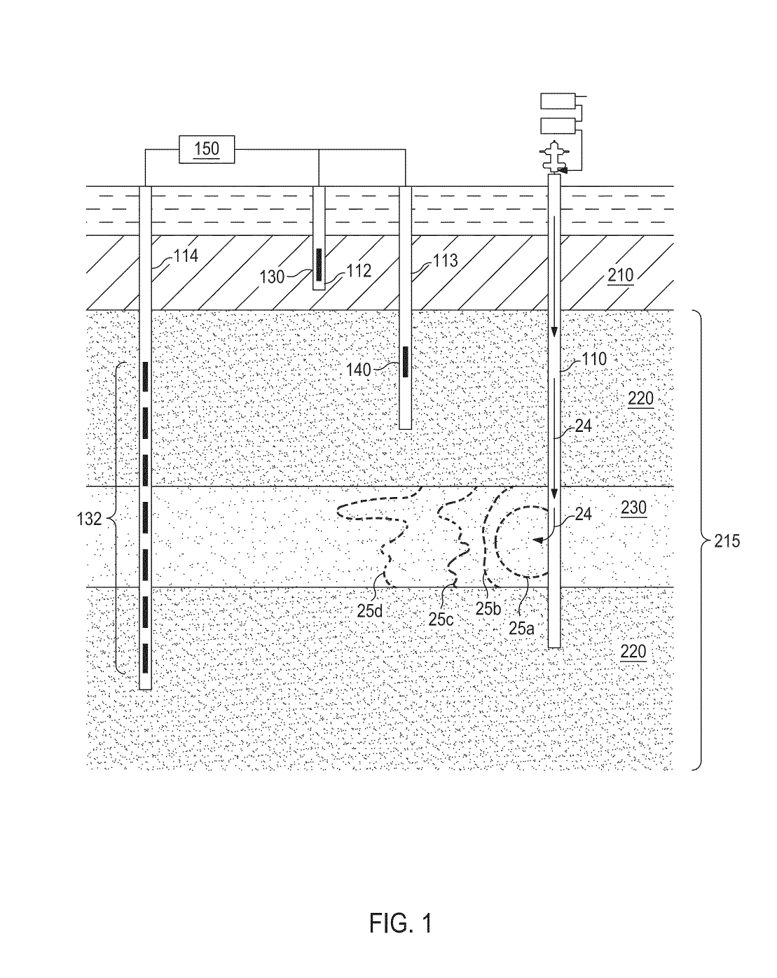

By way of nonlimiting example, FIG. 1 is a schematic illustration of an exemplary system configured to illuminate the pore space of a portion (230) of a subterranean formation (215) with a MILS fluid (24). The MILS fluid (24) is introduced from a primary well (110) and the local geo-electromagnetic field is measured from one or more monitoring wells, such as a first monitoring well (112), a second monitoring well (113), and a third monitoring well (114). The MILS fluid (24) may be introduced at a pressure below the matrix pressure of the formation (i.e., the pressure sufficient to create or extend at least one fracture in the subterranean formation) so as to cause the MILS fluid (24) to flow through the pore space within the portion (230) of the subterranean formation (215). As illustrated, the subterranean formation (215) comprises a portion (230) (illustrated as a strata) having high permeability disposed between the two very low permeability strata (220), wherein the MILS fluid (24) flows preferentially through the pore space of the more permeable portion (230) of the subterranean formation (215).

The measurements of the local geo-electromagnetic field of the portion (230) of the subterranean formation (215) may be with individual sensors in monitoring wells, sensor arrays in monitoring wells, individual sensors in the primary well, sensor arrays in the primary well, and combinations thereof. As illustrated in FIG. 1, the first and second monitoring wells (112), (113) may have first and second sensors (130) and (140), respectively, arranged therein. The third monitoring well (114), however, may have at least one sensor array (132) arranged therein.

The location and depth of the monitoring wells and depth of the sensors (or sensor arrays) in monitoring or primary wells may be configured depending on the size and volume of the portion of the subterranean formation (215) being analyzed, the desired degree of resolution of the pore space, and the like. As illustrated in FIG. 1, the first monitoring well (112) may be a shallow borehole in strata (210) with the first sensor (130) arranged therein. A typical shallow borehole for such a purpose may range from about ten feet to about forty feet in depth. The second monitoring well (113) may be a deeper borehole in strata (220) with the second sensor (140) arranged therein. The third monitoring well (114) may be an even deeper borehole that may, in at least one embodiment, penetrate the portion (230) of the subterranean formation (215), and the sensor array (132) may be arranged therein.

In some instances, the local geo-electromagnetic field measurements collected by the sensors may be transferred or otherwise conveyed (either wired or wirelessly) to a data processing system. In some instances, the local geo-electromagnetic field measurements collected by the sensors may be stored in a data storage portion of the sensor that may be retrieved by bringing the sensor to the surface or transferring the data as described above.

Referring again to FIG. 1, the local geo-electromagnetic field measurements collected by the first and second sensors (130), (140), and the sensor array (132) may be transferred or otherwise conveyed (either wired or wirelessly) to a data processing system (150) for determining the properties of the pore space.

As described above, a sequential series local geo-electromagnetic field measurements as the MILS fluid (24) penetrates the portion (230) of the subterranean formation (215) may provide a measure of the local permeability and conductivity of the pore space within the portion (230) of the subterranean formation (215). As additional MILS fluid (24) is introduced, or a flush fluid is introduced to push the MILS fluid (24) through the pore space, the incremental advancement of the MILS fluid (24) through the portion (230) of the subterranean formation (215) along various flow paths may be monitored. For example, the MILS location or progression through the pore space measured at different times (illustrated as lines (25a), (25b), (25c), and (25d)) may be compared to determine the shape of the flow paths and the speed that the MILS fluid (24) advances through each flow path.

Those skilled in the art will readily appreciate that the accuracy of mapping recorded events is dependent on the number and spacing of sensors and sensor arrays across the subterranean formation (215). Accordingly, embodiments are contemplated herein where additional sensors and sensor arrays (not shown in FIG. 3) are arranged in the monitoring wells (112), (113), (114), in additional monitoring wells, or in the primary well.

Some embodiments may involve performing illumination methods described herein in conjunction with a fracturing operation. Fracturing operations typically involve introducing a pad fluid (e.g., comprising base fluid and a viscosifying agent) into a subterranean formation via a wellbore at a pressure sufficient to create or extend at least one fracture in the subterranean formation, and introducing a proppant slurry (e.g., comprising base fluid and a plurality of proppants) into the subterranean formation so as to form a proppant pack in the at least one fracture. When the pressure is released, the fractures close but are left at least partially propped open with the proppant packs. In some instances, MILS may be included in the proppant slurry so as to monitor the location of the proppant slurry. In proppant slurries that are viscosified, the proppant slurry minimally invades the smaller pores and interstitial spaces of the void space, so the MILS will be primarily with the proppant. Therefore, when the pressure is released, the MILS may be useful in determining the dimensions of the fractures (natural or created) and other larger voids of the pore space of the subterranean formation, which may be presented as a 2-D and 3-D maps/profiles and may be compared to other formation data (e.g., seismic data, logging data, and the like).

Some embodiments of illumination methods may involve introducing a pad fluid into a wellbore penetrating a subterranean formation at a pressure sufficient to create or extend at least one fracture in the subterranean formation; introducing a proppant slurry into the subterranean formation, the proppant slurry comprising a base fluid, at least one magneto-responsive ionic liquid surfactant, and a plurality of proppants; forming a proppant pack in the at least one fracture; measuring a local geo-electromagnetic field within the subterranean formation at a first time and a second time; and determining dimensions of a fracture network comprising the at least one fracture based on differences between the local geo-electromagnetic field at the measurement at the first time and the measurement and the second time.

In some instances, the MILS may be included in the pad fluid to analyze the extent to which the fractures are formed during fracturing before the pressure is released and the fractures begin to close. Some embodiments of illumination methods may involve introducing a pad fluid into a wellbore penetrating a subterranean formation at a first pressure sufficient to create or extend at least one fracture in the subterranean formation, wherein the pad fluid comprises a base fluid and at least one magneto-responsive ionic liquid surfactant (and may optionally be viscosified with a viscosifying agent); measuring a local geo-electromagnetic field within the subterranean formation at a first time and a second time, wherein measuring of at least one of the first time and the second time is during introducing the pad fluid; and determining dimensions of the at least one fracture at based on differences between the local geo-electromagnetic field at the first time and the second time. For example, measuring a local geo-electromagnetic field within the subterranean formation may be at a second pressure sufficient to create or extend at least one fracture in the subterranean formation (which may be the same or different than the first pressure) or at a third pressure sufficient to maintain the dimensions of the at least one fracture.

As described above, measuring the local geo-electromagnetic field within the subterranean formation may be achieved by measuring the magnetic permeability, electrical conductivity, and electromagnetic field of the subterranean formation with one or more sensors.

In some embodiments, a combination of illumination methods may be used to determine the properties of the pore space of the subterranean formation. For example, an illumination method may be performed to determine the dimensions of the fractures and other larger voids of the pore space during a fracturing operation, then an illumination method may be performed with a flood (e.g., either with a continuous or push introduction of a MILS fluid) to determine the properties of the pore space.

Further, in some embodiments, illumination methods with MILS described herein may be useful in measuring the properties of the pore space or portions thereof (e.g., the fracture network) at various times during the production lifetime of the subterranean formation. For example, an annual analysis of the pore space may be performed using the illumination methods and MILS described herein. For example, such monitoring may be used to see if proppant is failing and the pore space is becoming less conductive from fracture closure such that a restimulation operation may be useful in enhancing production.

Exemplary embodiments described herein may include, but are not limited to,

A: a method that includes injecting a treatment fluid comprising a base fluid and at least one magneto-responsive ionic liquid surfactant into a wellbore penetrating a subterranean formation having a pore space; measuring a local geo-electromagnetic field within the subterranean formation at a first time and a second time; and determining a property of the pore space of the subterranean formation based on differences between the local geo-electromagnetic field at the first time and the second time;

B: a method that includes injecting a treatment fluid comprising a base fluid and at least one magneto-responsive ionic liquid surfactant into a wellbore penetrating a subterranean formation having a pore space; injecting a push fluid that does not comprise a magneto-responsive ionic liquid surfactant into the wellbore so as to push the treatment fluid through the subterranean formation; measuring a local geo-electromagnetic field within the subterranean formation at a first time and a second time; determining a property of the pore space of the subterranean formation based on differences between the local geo-electromagnetic field at the first time and the second time; and producing a multi-dimensional profile of the property of the pore space;

C: a method that includes introducing a pad fluid into a wellbore penetrating a subterranean formation at a pressure sufficient to create or extend at least one fracture in the subterranean formation; introducing a proppant slurry into the subterranean formation, the proppant slurry comprising a base fluid, at least one magneto-responsive ionic liquid surfactant, and a plurality of proppants; forming a proppant pack in the at least one fracture; measuring a local geo-electromagnetic field within the subterranean formation at a first time and a second time; and determining dimensions of a fracture network comprising the at least one fracture based on differences between the local geo-electromagnetic field at the first time and the second time; and

D: a method that includes introducing a pad fluid into a wellbore penetrating a subterranean formation at a pressure sufficient to create or extend at least one fracture in the subterranean formation, wherein the pad fluid comprises a base fluid and at least one magneto-responsive ionic liquid surfactant; measuring a local geo-electromagnetic field within the subterranean formation at a first time and a second time, wherein measuring of at least one of the first time and the second time is during introducing the pad fluid; and determining dimensions of a fracture network comprising the at least one fracture based on differences between the local geo-electromagnetic field at the first time and the second time.

Embodiments A-B may independently, optionally include at least one of the following elements in any combination: Element 1: wherein one of the first time and the second time is before injecting the treatment fluid; Element 2: the method further including injecting a push fluid after the treatment fluid so as to push the treatment fluid through the pore space of the subterranean formation; Element 3: wherein the property of the pore space is at least one selected from the group consisting of porosity, permeability, dimensions, connectivity, and any combination thereof; Element 4: wherein measuring a local geo-electromagnetic field involves measuring at least one selected from the group consisting of measuring the magnetic permeability, electrical conductivity, and electromagnetic field of the subterranean formation with one or more sensors; Element 5: Element 4 wherein at least one of the sensors is selected from the group consisting of a magnetometer, an electromagnetic field detector, a subsurface radar system, a magnetic susceptibility sensor, a magnetotelluric system, and any combination thereof; Element 6: Element 4 wherein the one or more sensors includes two or more sensors arranged in an array; Element 7: Element 4 wherein at least one of the one or more sensors is arranged within the wellbore; Element 8: Element 4 wherein at least one of the one or more sensors is arranged within a monitoring wellbore proximal to or penetrating the subterranean formation; Element 9: wherein the magneto-responsive ionic liquid surfactant comprises at least one anion of the group of iron chloride (FeCl₄), iron chloride bromide (FeCl₃Br), dysprosium chloride (DyCl₃), dysprosium sulfide (Dy₂S₃), gadolinium chloride (GdCl₃), erbium sulfide (Er₂S₃), manganese chloride (MnCl₂), and any derivative thereof; Element 10: wherein the MILS comprises at least one selected from the group consisting of C₆-C₂₂ alkylamines, quaternary ammonium surfactants having at least one C₆-C₂₂ group, (C₆-C₂₂ alkyl)-trimethylammonium surfactants, di-(C₆-C₂₂ alkyl)-dimethylammonium surfactants, benzalkonium surfactants where the alkyl group is C₆-C₂₂, (C₆-C₂₂ alkyl)-imidazole surfactants, and any derivative thereof; and Element 11: wherein the method further includes measuring the local geo-electromagnetic field within the subterranean formation at a third time. Exemplary combinations may include, but are not limited to, Element 9 in combination with Element 10; Element 1 in combination with Element 2; Element 2 in combination with at least one of Elements 3-8; Elements 1 and 2 in combination with at least one of Elements 3-8; Element 9 in combination with any of the foregoing; Element 10 in combination with any of the foregoing; Element 11 in combination with any of the foregoing; and so on.

Embodiments C-D may independently, optionally include at least one of the following elements in any combination: Element 12: wherein one of the first time and the second time is before injecting the pad fluid; Element 13: wherein measuring a local geo-electromagnetic field involves measuring at least one selected from the group consisting of measuring the magnetic permeability, electrical conductivity, and electromagnetic field of the subterranean formation with one or more sensors; Element 14: Element 13 wherein at least one of the sensors is selected from the group consisting of a magnetometer, an electromagnetic field detector, a subsurface radar system, a magnetic susceptibility sensor, a magnetotelluric system, and any combination thereof; Element 15: Element 13 wherein the one or more sensors includes two or more sensors arranged in an array; Element 16: Element 13 wherein at least one of the one or more sensors is arranged within the wellbore; Element 17: Element 13 wherein at least one of the one or more sensors is arranged within a monitoring wellbore proximal to or penetrating the subterranean formation; Element 18: wherein the magneto-responsive ionic liquid surfactant comprises at least one anion of the group of iron chloride (FeCl₄), iron chloride bromide (FeCl₃Br), dysprosium chloride (DyCl₃), dysprosium sulfide (Dy₂S₃), gadolinium chloride (GdCl₃), erbium sulfide (Er₂S₃), manganese chloride (MnCl₂), and any derivative thereof; Element 19: wherein the MILS comprises at least one selected from the group consisting of C₆-C₂₂ alkylamines, quaternary ammonium surfactants having at least one C₆-C₂₂ group, (C₆-C₂₂ alkyl)-trimethylammonium surfactants, di-(C₆-C₂₂ alkyl)-dimethylammonium surfactants, benzalkonium surfactants where the alkyl group is C₆-C₂₂, (C₆-C₂₂ alkyl)-imidazole surfactants, and any derivative thereof; and Element 20: wherein the method further includes measuring the local geo-electromagnetic field within the subterranean formation at a third time. Exemplary combinations may include, but are not limited to, Element 18 in combination with Element 19; Element 20 in combination with at least one of Elements 13-17; Element 18 in combination with any of the foregoing; Element 19 in combination with any of the foregoing; Element 20 in combination with any of the foregoing; and so on.

To facilitate a better understanding of the present invention, the following examples of preferred or representative embodiments are given. In no way should the following examples be read to limit, or to define, the scope of the invention.

### EXAMPLES

A MILS 1-methyl-3-nonylimidazolium tetrachloroferrate (FeCl₄) anion was prepared. The MILS was a viscous, brown liquid at room temperature. At approximately 20% by weight in an aqueous solution, the diluted MILS was an amber color.

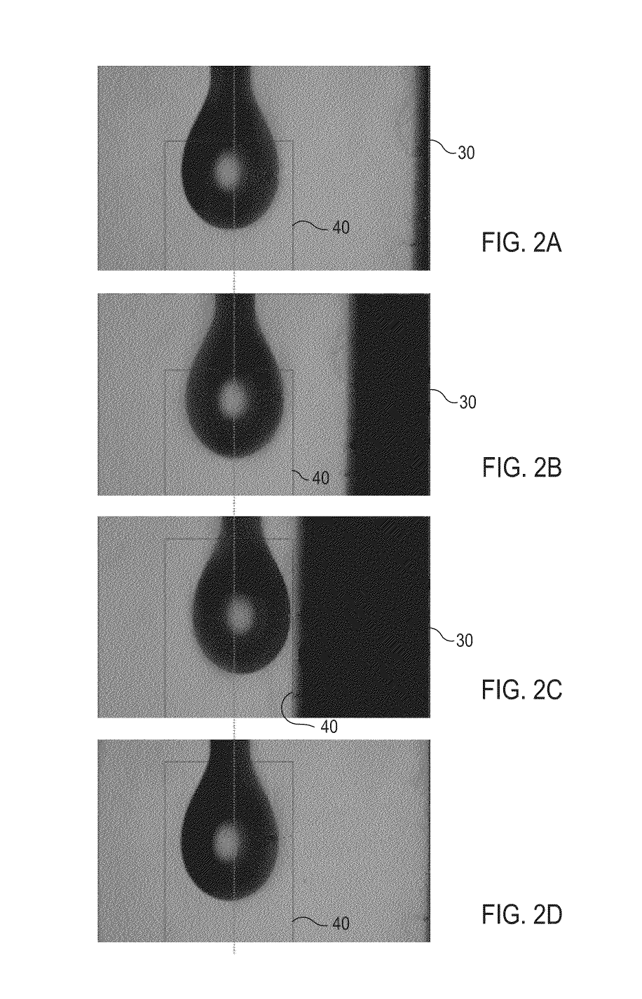

FIGS. 2A-2D depict the motion of a drop of the diluted MILS as a magnet (30) with a magnetic flux density of less than 0.1 T at its surface is brought into proximity of the drop of the diluted MILS. The reference frame (40) is stationary throughout the FIGS. 2A-2D so as to provide a reference for the extent to which the drop moves in response to the distance between the magnet (30) and the drop. In FIG. 2A, the magnet is within the field of view and the drop appears to be centered in the reference frame (40). In FIG. 2B the magnet is closer and the drop is attracted to the magnet. Still further in FIG. 2C the magnet is moved even closer to the drop and the drop moves further off-center towards the magnet. In FIG. 2D when the magnet is removed from the field of view, the drop returns to the center of the reference frame (40).

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method, comprising:
injecting a treatment fluid comprising a base fluid and at least one magneto-responsive ionic liquid surfactant into a wellbore penetrating a subterranean formation having a pore space;
measuring a local geo-electromagnetic field within the subterranean formation at a first time and a second time; and
determining a property of the pore space of the subterranean formation based on differences between the local geo-electromagnetic field at the first time and the second time.

2. The method of claim 1, wherein one of the first time and the second time is before injecting the treatment fluid.

3. The method of claim 1 further comprising:
injecting a push fluid after the treatment fluid so as to push the treatment fluid through the pore space of the subterranean formation.

4. The method of claim 1, wherein the property of the pore space is at least one selected from the group consisting of porosity, permeability, dimensions, connectivity, and any combination thereof.

5. The method of claim 1, wherein measuring a local geo-electromagnetic field involves measuring at least one selected from the group consisting of measuring the magnetic permeability, electrical conductivity, and electromagnetic field of the subterranean formation with one or more sensors.

6. The method of claim 5, wherein at least one of the sensors is selected from the group consisting of a magnetometer, an electromagnetic field detector, a subsurface radar system, a magnetic susceptibility sensor, a magnetotelluric system, and any combination thereof.

7. The method of claim 5, wherein the one or more sensors includes two or more sensors arranged in an array.

8. The method of claim 5, wherein at least one of the one or more sensors is arranged within the wellbore.

9. The method of claim 5, wherein at least one of the one or more sensors is arranged within a monitoring wellbore proximal to or penetrating the subterranean formation.

10. The method of claim 1, wherein the magneto-responsive ionic liquid surfactant comprises at least one anion of the group of iron chloride (FeCl₄), iron chloride bromide (FeCl₃Br), dysprosium chloride (DyCl₃), dysprosium sulfide (Dy₂S₃), gadolinium chloride (GdCl₃), erbium sulfide (Er₂S₃), manganese chloride (MnCl₂), and any derivative thereof.

11. The method of claim 1, wherein the MILS comprises at least one selected from the group consisting of C₆-C₂₂ alkylamines, quaternary ammonium surfactants having at least one C₆-C₂₂ group, (C₆-C₂₂ alkyl)-trimethylammonium surfactants, di-(C₆-C₂₂ alkyl)-dimethylammonium surfactants, benzalkonium surfactants where the alkyl group is C₆-C₂₂, (C₆-C₂₂ alkyl)-imidazole surfactants, and any derivative thereof.

12. A method, comprising:
injecting a treatment fluid comprising a base fluid and at least one magneto-responsive ionic liquid surfactant into a wellbore penetrating a subterranean formation having a pore space;
injecting a push fluid that does not comprise a magneto-responsive ionic liquid surfactant into the wellbore so as to push the treatment fluid through the subterranean formation;
measuring a local geo-electromagnetic field within the subterranean formation at a first time and a second time;
determining a property of the pore space of the subterranean formation based on differences between the local geo-electromagnetic field at the first time and the second time; and
producing a multi-dimensional profile of the property of the pore space.

13. A method, comprising:
introducing a pad fluid into a wellbore penetrating a subterranean formation at a pressure sufficient to create or extend at least one fracture in the subterranean formation;
introducing a proppant slurry into the subterranean formation, the proppant slurry comprising a base fluid, at least one magneto-responsive ionic liquid surfactant, and a plurality of proppants;
forming a proppant pack in the at least one fracture;
measuring a local geo-electromagnetic field within the subterranean formation a first time and a second time; and
determining dimensions of a fracture network comprising the at least one fracture based on differences between the local geo-electromagnetic field at the first time and the second time.

14. The method of claim 13, wherein one of the first time and the second time is before injecting the pad fluid.

15. The method of claim 13, wherein measuring a local geo-electromagnetic field involves measuring at least one selected from the group consisting of measuring the magnetic permeability, electrical conductivity, and electromagnetic field of the subterranean formation with one or more sensors.

16. The method of claim 15, wherein at least one of the sensors is selected from the group consisting of a magnetometer, an electromagnetic field detector, a subsurface radar system, a magnetic susceptibility sensor, a magnetotelluric system, and any combination thereof.

17. The method of claim 15, wherein at least one of the one or more sensors is arranged within the wellbore.

18. The method of claim 15, wherein at least one of the one or more sensors is arranged within a monitoring wellbore proximal to or penetrating the subterranean formation.

19. The method of claim 13, wherein the magneto-responsive ionic liquid surfactant comprises at least one anion of the group of iron chloride (FeCl₄), iron chloride bromide (FeCl₃Br), dysprosium chloride (DyCl₃), dysprosium sulfide (Dy₂S₃), gadolinium chloride (GdCl₃), erbium sulfide (Er₂S₃), manganese chloride (MnCl₂), and any derivative thereof.

20. The method of claim 13, wherein the MILS comprises at least one selected from the group consisting of C₆-C₂₂ alkylamines, quaternary ammonium surfactants having at least one C₆-C₂₂ group, (C₆-C₂₂ alkyl)-trimethylammonium surfactants, di-(C₆-C₂₂ alkyl)-dimethylammonium surfactants, benzalkonium surfactants where the alkyl group is C₆-C₂₂, (C₆-C₂₂ alkyl)-imidazole surfactants, and any derivative thereof.
